(19) United States
(12) Patent Application Publication
(10) Pub. No.: US 2002/0012742 A1
(43) Pub. Date: Jan. 31, 2002

(54) Apparatus for impregnating porous parts

(76) Inventor: Emerson Richard Gallagher, Vancouver (CA)

Correspondence Address: Robert W. Fieseler, McAndrews, Held & Malloy, Ltd., 34th Floor, 500 West Madison Street, Chicago, IL, 60661, US

(21) Appl. No.: 09/896,177

(22) Filed: Jun. 29, 2001

Related U.S. Application Data
(63) Continuation of application No. 09/618,678, filed on Jul. 19, 2000, now abandoned.

(51) Int. Cl. B05D 1/00

(52) U.S. Cl. 427/8; 118/712

(57) ABSTRACT

An apparatus for impregnating porous parts comprises a vessel for holding at least one porous part and an impregnant, and a measuring device for measuring the change in weight of the part(s) immersed in the impregnant within the vessel.

### CROSS-REFERENCE TO RELATED APPLICATION

This application is a continuation of U.S. patent application Ser. No. 09/618,678 filed Jul. 19, 2000, which is incorporated by reference herein in its entirety.

### FIELD OF THE INVENTION

The present process and apparatus relate to processes for controlling the extent of impregnation of porous parts during the impregnation thereof. In particular, the present process and apparatus provide for control of the extent of impregnation by measuring the change in buoyancy of the parts during the impregnation process.

### BACKGROUND OF THE INVENTION

Impregnation of porous parts is a common technique employed in a variety of industries for a variety of reasons. Stone, brick, ceramic, wood, polymer, aggregate, cermet, and porous metal parts, for example, are commonly impregnated. Commonly, a sealant is impregnated into the part because the porosity is undesirable in the intended end use of the part. In some applications, it is only necessary to seal the pores on the surface of the part. In other applications, thorough impregnation of the part is necessary. Further, in certain applications it may be possible to over-impregnate a part, so careful control of the level of impregnation is required.

For example, separator plates are a component of fuel cells, including solid polymer electrolyte fuel cells. Separator plates are required to be electrically conductive and to be substantially impermeable to the fluid reactants and/or coolants used in the fuel cell or fuel cell stack. They are commonly made from graphitized carbon, carbon-resin composites, or graphite. The plates are typically impregnated with a resin that assists in imparting the necessary impermeability and mechanical stability. The plates should be thoroughly impregnated with resin.

Expanded graphite sheets, such as the material available from UCAR Carbon Technology Corp. (Danbury, Conn.) under the tradename GRAFOIL, may be used to form separator plates for fuel cells. Expanded graphite sheets are useful in this regard because they are relatively light, flexible and amenable to low-cost manufacturing methods, such as embossing. Separator plates made from expanded graphite sheet may be impregnated with a suitable resin in order to achieve the desired impermeability and conductivity discussed above. It is important that such plates be sufficiently impregnated to meet performance requirements. At the same time, it is possible to over-impregnate the plates, resulting in degradation or loss of desired structural and/or functional properties. Accordingly, impregnation process control is an important aspect of separator plate manufacture.

Conventional impregnation process control methods typically rely on a consistent time required to sufficiently impregnate a part. Based on such methods, an optimum time can be selected to ensure adequate impregnation without much wasted time or expenditure. However, where relatively subtle process and/or material changes can drastically affect the proper impregnation time necessary to achieve the desired impregnation level, such methods are unsatisfactory. For example, the variability of different grades, lots and batches of expanded graphite sheet, as well as variations in separator plate processing or design, has made it virtually impossible to determine an appropriate impregnation time beforehand for a given lot of separator plates.

Current methods use the impregnation time from the previous batch of plates as the initial time estimate for impregnation of the next batch, taking into account other factors such as plate thickness, density, etc. Since the level of impregnation can only be assessed after the impregnation process is complete, entire batches of parts may have to be scrapped due to incorrect estimates of the impregnation time. This approach is costly in terms of time and materials, and is poorly suited to high-volume production methods. Accordingly, a method of controlling the impregnation of porous parts that allows the extent of impregnation to be predictably controlled is desirable.

The present process and apparatus address the problems associated with the prior art impregnation control processes. Specifically, the present process and apparatus allow the extent of impregnation of a porous part to be controlled during the impregnation process.

### SUMMARY OF THE INVENTION

A process for impregnating at least one porous part with an impregnant is provided comprising:

(a) immersing at least one porous part in impregnant;

(b) measuring at least one parameter indicative of the buoyancy of the part(s) as the impregnant impregnates same; and

(c) interrupting impregnation when the measured parameter(s) indicates a predetermined level of impregnation is achieved.

The measured parameter may comprise the change in weight of the part(s), the rate of change in weight of the part(s), or both. Preferably, the measured parameter(s) is (are) measured continuously. Impregnation may be interrupted when the change in weight exceeds a predetermined threshold value, when the rate of change in weight falls below a predetermined threshold value, or both. The measured parameter(s) may be compared to a reference parameter value and impregnation may be interrupted when the measured parameter(s) varies from the reference parameter value(s) by less than a predetermined threshold amount. For example, impregnation may be interrupted when the measured parameter indicates that at least 85% of the void volume of the porous part(s) is impregnated, or alternatively, when the measured parameter indicates that at least 95% of the void volume of the porous part(s) is impregnated.

The process may further comprise sending an output signal representative of the measured parameter(s) to a controller, which may comprise a display for displaying the measured parameter(s) represented by the output signal(s). Impregnation may be interrupted in response to an output signal from the controller.

The at least one porous part may comprise a carbon plate, including but not limited to a graphite plate. For example, the at least one porous part may comprise an expanded graphite plate.

The impregnant may be any suitable impregnant. Where graphite plates are impregnated, particularly suitable impregnants include resins such as phenols, epoxies, melamines, furans and methacrylates.

The porous part(s) may be impregnated at any suitable pressure. For example, the porous part(s) may be impregnated at ambient pressure, at a pressure less than atmospheric pressure, at a pressure greater than atmospheric pressure, or any combination thereof.

Where a plurality of porous parts is impregnated according to the present method and apparatus, the measured parameter may be indicative of the level of impregnation of all of the porous parts, or only a portion thereof. For example, the measured parameter may comprise the change in weight, rate of change in weight, or both, of all of the porous parts being impregnated. Alternatively, the measured parameter may comprise the change in weight, rate of change in weight, or both, of a representative sample of the porous parts being impregnated.

An apparatus for impregnating porous parts is also provided comprising a vessel for holding at least one porous part and an impregnant, and at least one measuring device for measuring the change in weight of the part(s) immersed in the impregnant within the vessel. The apparatus may further comprise a pump fluidly connected to the vessel for varying the pressure therein from ambient pressure.

The measuring device(s) may comprise an electronic balance having a cantilever arm connected at one end to the balance, the other end of the arm being suspended in the vessel. The suspended end being removably attachable to the porous part(s) for measuring the change in weight thereof. Alternatively, the measuring device(s) may comprise a load cell associated with the interior of the vessel. Preferably, the at least one measuring device generates output signals representative of the measured parameter(s). The apparatus may further comprise a controller for receiving the output signals from the measuring device(s), and the controller may comprise a display for displaying the change in weight represented by the output signals.

### BRIEF DESCRIPTION OF THE DRAWINGS

FIG. 1 is a schematic illustration of an embodiment of the present apparatus.

FIG. 2 is a schematic illustration of a preferred embodiment of the present apparatus.

FIG. 3 is a graph of the load cell voltage as a function of time during impregnation of expanded graphite plates (of one grade) according to the present method and apparatus.

FIG. 4 is a graph of the load cell voltage as a function of time during impregnation of expanded graphite plates (of another grade) according to the present method and apparatus.

### DETAILED DESCRIPTION OF PREFERRED EMBODIMENT(S)

The present process and apparatus allow for control of the level of impregnation of porous parts by measuring the change in buoyancy of the parts during the impregnation process. The present process and apparatus may be applicable to the impregnation of any porous parts by an impregnant. Such porous parts may include, for example, stone, brick, ceramic, wood, polymer, aggregate, cermet, and porous metal parts, as well as parts comprising porous carbon. Any suitable liquid impregnant may also be used, depending upon the application. The present process and apparatus are particularly applicable to impregnation of porous parts where batch-to-batch variability makes impregnation processes based on a constant, predictable impregnation time unsuitable, or where a target level of impregnation is required for performance or cost effectiveness.

When dry porous parts are placed in a liquid impregnant, they are comprised of solids of a known density and empty voids. As such, they have an initial buoyancy in the impregnant. As the voids are filled with impregnant, the effective mass of the parts increases while the effective volume remains constant. Thus, as impregnant fills the voids the buoyancy of the parts decreases and their apparent weight in the impregnant increases. By measuring the magnitude of this weight change, it may be possible to determine the level of impregnation of the part. Preferably, the rate of change in buoyancy of the part is also measured to determine the level of impregnation of the part. When the change in buoyancy and/or the rate of change in buoyancy indicates the desired level of impregnation has been achieved, the part may be removed from the impregnant, or the impregnation process otherwise interrupted.

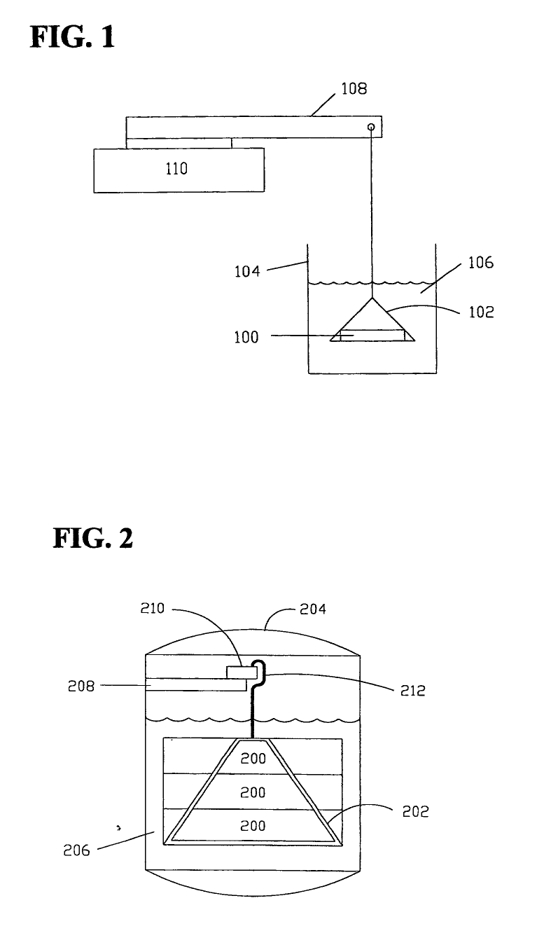

FIG. 1 is a schematic illustration of an embodiment of the present apparatus. Porous part 100 is supported by frame 102. Frame 102 is suspended in vessel 104 filled with liquid impregnant 106. Frame 102 is attached to one end of cantilever arm 108. The other end of cantilever arm 108 is movably attached to electronic balance 110. In an embodiment of the present method, porous part 100 and frame 102 are suspended from cantilever arm 108 and immersed in impregnant 106. At this point (time zero) porous part 100 will have an initial buoyancy and part 100 and frame 102 will have an initial weight that will be detected by scale 110. Preferably, balance 110 is tared at time zero so that any weight measured thereafter represents the change in apparent weight of part 100. As impregnant fills the voids in part 100, the buoyancy of part 100 decreases and the apparent weight of part 100 measured by balance 110 increases. The change in weight of part 100, the rate of change in weight of part 100, or both, may be measured and used to determine when the desired level of impregnation is achieved.

FIG. 2 is a schematic illustration of a preferred embodiment of the present apparatus. Porous parts 200 are supported by frame 202, which is suspended in vessel 204 containing impregnant 206. Cantilever arm 208 is fixed at one end to the inner surface of vessel 204 and the other end extends into the interior volume thereof. Load cell 210 is attached to one end of cantilever arm 208. Hook 212 of frame 202 rests on load cell 210. In a preferred embodiment of the present method, porous parts 200 are suspended in frame 202 by hook 212 and immersed in impregnant 206. At this point (time zero) porous parts 200 will have an initial buoyancy and parts 200 and frame 102 will have an initial weight. Load cell 210 will measure a force corresponding to this initial weight. As impregnant fills the voids in parts 200, their buoyancy decreases and their apparent weight increases, increasing the force exerted on load cell 210. The change in weight of parts 200, the rate of change in weight of parts 200, or both, may be measured and used to determine when the desired level of impregnation is achieved.

The desired level of impregnation of the porous parts may depend on the application. For example, where the porous parts are expanded graphite fuel cell plates preferably at least 85% of the void volume should be filled with impregnant, more preferably at least 95%. The amount of variation from the desired level of impregnation may vary with the particular application, and may depend on the specification tolerance of the impregnated product. For example, it may be desirable to selected the desired level of impregnation of expanded graphite fuel cell plates at 90%, within ±5%.

The desired level of impregnation may be determined from the change in buoyancy of the parts, as determined by their change in weight in the impregnant. Porous parts of a known volume and density will have voids of a given total volume. By calculating the volume of impregnant in the part(s), based on the density of the impregnant, it is possible to calculate the percentage of void volume of the part that is filled. Alternatively, the change in weight of the part(s) over time can be plotted. The rate of change in weight at a given time may be indicative of the proportion of total void volume filled with impregnant. As a further alternative, the rate of change in weight may be plotted with test pieces and the resulting graph may be used to determine the change in weight corresponding to a desired level of impregnation.

The impregnation can be performed at atmospheric pressure, if desired, or at a lower or higher pressure. For example, it may be desirable to impregnate the part(s) under reduced pressure in order to remove air entrained in the impregnant. Alternatively, it may be desirable to impregnate at super-atmospheric pressure in order to force the impregnant into the pores of the part(s) being impregnated. As a further example, impregnation may be initiated at a reduced pressure to remove excess air, and then the pressure may be increased to super-atmospheric pressure in order to assist penetration of the impregnant into the porous part(s).

Any liquid impregnant may be used in the present method and apparatus. The choice of impregnant will be determined by such factors as compatibility with the porous part and desired characteristics of the impregnant and of the impregnated part. Suitable impregnants for expanded graphite fuel cell plates, for example, are preferably stable, curable and capable of substantially filling the voids in the plate. Known resins suitable for such purposes include phenols, epoxies, melamines, furans, and methacrylates. The choice of impregnant is not essential to the present method and apparatus, and the appropriate impregnant for a given application may be determined by those skilled in the art.

Any suitable load measuring device may be used in the present method and apparatus. For example, the load cell illustrated in FIG. 2 may be a bending beam, shear beam, canister, ring-and-pancake, or button-and-washer load cell. Other load measuring devices will be known to those skilled in the art.

Preferably, the load measuring device generates an output signal representative of the measured change in weight of the porous part(s) during impregnation. The present apparatus may further comprise a controller for receiving the output signals from the load measuring device. The controller may also display the measured change and/or rate of change in weight. The controller could be programmed to interrupt the impregnation process in response to the measured parameter(s). For example, the controller could interrupt impregnation when the change in weight of the porous parts exceeded a predetermined threshold value, or differed from a threshold value by a predetermined amount. Alternatively, the controller could interrupt the process when the rate of change in weight of the porous part(s) falls below a given threshold amount. As a further example, the controller may interrupt the process when either of the foregoing conditions is met.

In batch processes where a large number of porous parts are impregnated at the same time it may not be desirable to measure the change in weight of the entire batch. If desired, the change in weight of a portion of the porous parts to be impregnated may be measured. Referring to FIG. 2, for example, parts 200 may be a representative sample of a larger batch of such parts. Assuming that the parts chosen as a sample are representative of the entire batch, the change in buoyancy of the sample should reflect the corresponding change in the batch as a whole. Thus, a desired level of impregnation of the batch may be achieved by measuring the change in buoyancy of a portion thereof.

The following examples are for purposes of illustration and are not intended to limit the invention.

### EXAMPLE 1

Expanded graphite sheet fuel cell plates were impregnated in an impregnation vessel according to the present method. The plates were made from embossed GRAFOIL having a sub-80 mesh graphite flake particle size and an area weight of 70 mg/cm². The impregnation vessel was a S-24 x 30-AUB (Imprex, Milwaukee, Wis.) unit modified by the addition of a cantilever arm, load cell and a metal frame suspended therefrom, as described in FIG. 2 and supporting text, above, and contained methacrylate resin. The load cell (45 N shear beam) was connected to a Goerz Servogor 124 chart recorder via a variable gain and offset instrumentation amplifier for recording the voltage output of the load cell in response to the load exerted on it by the frame and plates during the impregnation process.

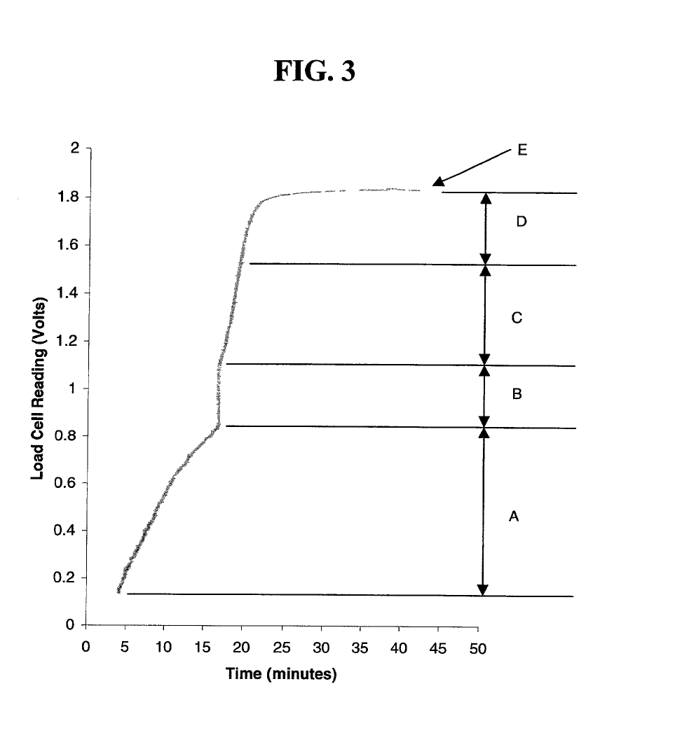

FIG. 3 is a graph of the load cell voltage as a function of time during impregnation. Ten (10) of the foregoing GRAFOIL plates were placed on the frame and immersed in the resin in the impregnation vessel. The impregnation vessel was sealed and the pressure inside the impregnation vessel was decreased from ambient to 2 torr (0.3 kPa) for 15 minutes to remove entrained air from the plates and resin (part A of FIG. 3). The vacuum was released (part B of FIG. 3), and then the pressure inside the impregnation vessel was increased from ambient to 620 kPa (part C of FIG. 3). The plates were allowed to soak at that pressure (part D of FIG. 3) until the chart recording indicated that about 98-99% of the void volume of the plates had been filled by the resin (point E of FIG. 3), i.e., when the curve substantially flattened. The impregnation process was interrupted at this time and the plates were removed from the vessel. The total elapsed time was 40 minutes.

### EXAMPLE 2

The same procedure was described in Example 1 was followed, except that six (6) plates were impregnated and the plates were made of GRAFOIL having an 80 mesh graphite flake particle size, and area weight of 70 mg/cm², and ceramic fibers imbedded therein. The total elapsed time of the impregnation process was 30.5 minutes.

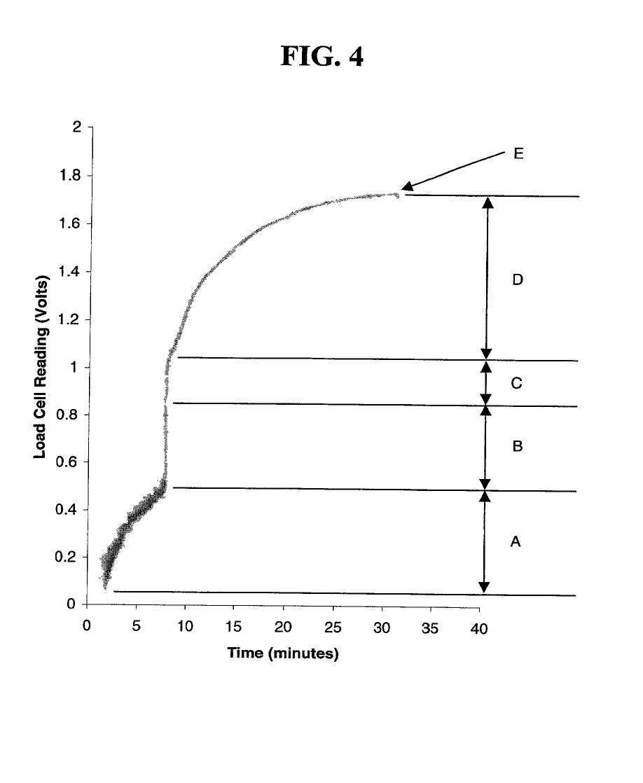

FIG. 4 is a graph of the load cell voltage as a function of time during impregnation. The designations used in FIG. 4 for the parts of the graph corresponding to the steps in the process are the same as those used in FIG. 3.

While particular elements, embodiments and applications of the present invention have been shown and described, it will be understood, of course, that the invention is not limited thereto since modifications may be made by those skilled in the art, particularly in light of the foregoing teachings. It is therefore contemplated by the appended claims to cover such modifications that incorporate those features coming within the scope of the invention.

What is claimed is:

1. An apparatus for impregnating a porous part, the apparatus comprising:
(a) a vessel for holding the porous part and an impregnant; and
(b) a measuring device for measuring at least one parameter indicative of the buoyancy of the porous part immersed in the impregnant within the vessel.

2. The apparatus of claim 1 wherein the measuring device measures the change in weight of the porous part.

3. The apparatus of claim 1 wherein the measuring device measures the rate of change in weight of the porous part.

4. The apparatus of claim 1 further comprising a pump fluidly connected to the vessel for reducing the pressure therein below atmospheric pressure.

5. The apparatus of claim 1 further comprising a pump fluidly connected to the vessel for increasing the pressure therein above atmospheric pressure.

6. The apparatus of claim 1 wherein the measuring device comprises an electronic balance having a cantilever arm connected at one end to the balance, the other end of the arm suspended in the vessel, wherein the other end of the arm is removably attachable to a container for supporting the porous part.

7. The apparatus of claim 1 wherein the measuring device comprises a load cell.

8. The apparatus of claim 1 wherein the measuring device generates output signals representative of the at least one measured parameter.

9. The apparatus of claim 8, further comprising a controller for receiving the output signals from the measuring device.

10. The apparatus of claim 9 wherein the controller comprises a display for displaying the measured parameter represented by the output signals.

11. The apparatus of claim 1 wherein the porous part comprises a plurality of porous parts.

12. The apparatus of claim 11, further comprising a container for supporting the plurality of porous parts in the vessel.

13. The apparatus of claim 1 wherein the porous part comprises a portion of a plurality of porous parts.

14. The apparatus of claim 13, further comprising a container for supporting portion of the plurality of porous parts in the vessel.
